(19) United States
(12) Patent Application Publication
(10) Pub. No.: US 2012/0026170 A1
(43) Pub. Date: Feb. 2, 2012

(54) PROJECTION DISPLAY APPARATUS

(75) Inventors: Takaaki ABE, Osaka-City (JP); Masutaka INOUE, Hirakata-City (JP); Susumu TANASE, Kadoma-City (JP); Masahiro HARAGUCHI, Daito-City (JP); Yoshinao HIRANUMA, Hirakata-City (JP); Tomoya TERAUCHI, Daito-City (JP); Noboru YOSHINOBE, Hirakata-City (JP)

(73) Assignee: SANYO Electric Co., Ltd., Osaka (JP)

(21) Appl. No.: 13/192,994

(22) Filed: Jul. 28, 2011

(30) Foreign Application Priority Data
Jul. 29, 2010 (JP) 2010-171211
Jul. 5, 2011 (JP) 2011-149475

(51) Int. Cl. G06T 15/50; G09G 5/02

(52) U.S. Cl. 345/426; 345/589

(57) ABSTRACT

A projection display apparatus according to embodiments includes a light source that emits color component light beams of a plurality of colors and an imager that modulates the color component light beams of a plurality of colors emitted from the light source. The projection display apparatus includes an element control unit that controls the imager; and a light source control unit that controls the light source. The element control unit controls the imager based on an image output signal obtained by a signal expansion process of an image input signal. The light source control unit performs a power reduction process of reducing power supplied to the light source according to an expansion amount of the image input signal expanded by the signal expansion process. The light source control unit performs a light emission period control process of adjusting light emission periods of a color component light beams of a plurality of colors emitted from the light source within a 1-frame period according to the image input signal.

### CROSS REFERENCE TO RELATED APPLICATIONS

This application is based upon and claims the benefit of priority from prior Japanese Patent Application No.2010-171211, filed on Jul. 29, 2010; and prior Japanese Patent Application No.2011-149475, filed on Jul. 5, 2011; the entire contents of which are incorporated herein by reference.

### BACKGROUND OF THE INVENTION

1. Field of the Invention

The present invention relates to a projection display apparatus including a light source that emits color component light beams of a plurality of colors and an imager that modulates the color component light beams of a plurality of colors emitted from the light source.

2. Description of the Related Art

Conventionally, there is known a projection display apparatus configured to adjust a light emission period of color component light beams of a plurality of colors emitted from a light source within a 1-frame period according to an image input signal.

There is proposed a projection display apparatus configured to maintain a color balance by dynamically controlling a period during which light is emitted from a light source (hereinafter, “light emission period”) (for example, JP-A-2006-53350).

However, when the light emission period is simply shortened, a graduation crush between low luminance pixels may occur.

### SUMMARY OF THE INVENTION

A projection display apparatus according to a first feature includes a light source that emits color component light beams of a plurality of colors and an imager that modulates the color component light beams of a plurality of colors emitted from the light source. The projection display apparatus includes an element control unit that controls the imager; and a light source control unit that controls the light source. The element control unit controls the imager based on an image output signal obtained by a signal expansion process of an image input signal. The light source control unit performs a power reduction process of reducing power supplied to the light source according to an expansion amount of the image input signal expanded by the signal expansion process. The light source control unit performs a light emission period control process of adjusting light emission periods of a color component light beams of a plurality of colors emitted from the light source within a 1-frame period according to the image input signal.

In the first feature, the light source control unit performs a power adjustment process of reducing power supplied to the light source according to an adjustment amount of the light emission period adjusted by the light emission period control process.

In the first feature, the light source control unit performs a power adjustment process of increasing power supplied to the light source in a range not exceeding an allowed power value that can be supplied to the light source.

In the first feature, the image input signal includes color input signals for each color component light beam of a plurality of colors, and the element control unit applies an expansion amount of any one of a color input signal to the other color input signal, among the color input signals for each color component light beam of a plurality of colors, in the signal expansion process.

In the first feature, the image input signal includes color input signals for each color component light beam of a plurality of colors. In the color input signals for each color component light beam of a plurality of colors, an upper limit value is predefined. The element control unit expands each of the color input signals for each color component light beam of a plurality of colors to the upper limit value in the signal expansion process.

In the first feature, when displaying a three-dimensional image formed by a plurality of viewpoint images, the element control unit and the light source control unit apply the same process, as the signal expansion process, the power reduction process, and the light emission period control process, to the plurality of viewpoint images.

In the first feature, the projection display apparatus includes a mode control unit that controls a high efficiency mode in which a light emission efficiency of the light source is high and a high luminance mode in which a luminance of an image is high.

In the first feature, when displaying a three-dimensional image formed by a plurality of viewpoint images, the mode control unit applies the same control mode, among the high luminance mode and the high efficiency mode, to the plurality of viewpoint images.

### BRIEF DESCRIPTION OF THE DRAWINGS

FIG. 1 is a diagram illustrating a projection display apparatus 100 according to a first embodiment.

FIG. 2 is a block diagram illustrating a control unit 200 according to the first embodiment.

FIG. 3 is a diagram for explaining common control 1 according to the first embodiment.

FIG. 4 is a diagram for explaining common control 2 according to the first embodiment.

FIG. 5 is a diagram for explaining common control 3 according to the first embodiment.

FIG. 6 is a diagram illustrating a light emission period according to a first modification.

FIG. 7 is a diagram illustrating a light emission period according to the first modification.

FIG. 8 is a diagram illustrating a light emission period according to the first modification.

FIG. 9 is a diagram explaining a control example 1 of Example.

FIG. 10 is a diagram explaining a control example 1 of Example.

FIG. 11 is a graph explaining a control example 1 of Example.

FIG. 12 is a graph explaining a control example 1 of Example.

FIG. 13 is a table explaining a control example 1 of Example.

FIG. 14 is a diagram explaining a control example 2 of Example.

FIG. 15 is a table explaining a control example 2 of Example.

FIG. 16 is a diagram explaining a control example 3 of Example.

FIG. 17 is a table explaining a control example 3 of Example.

FIG. 18 is a diagram explaining a control example 4 of Example.

FIG. 19 is a table explaining a control example 4 of Example.

FIG. 20 is a diagram explaining another control example of Example.

FIG. 21 is a diagram explaining the other control example of Example.

FIG. 22 is a graph explaining the other control example of Example.

FIG. 23 is a graph explaining the other control example of Example.

### DETAILED DESCRIPTION OF THE EMBODIMENTS

Hereinafter, a projection display apparatus according to embodiments of the present invention is explained with reference to drawings. In the following drawings, same or similar parts are denoted with same or similar reference numerals.

### Overview of Embodiments

A projection display apparatus according to embodiments includes a light source that emits color component light beams of a plurality of colors and an imager that modulates the color component light beams of a plurality of colors emitted from the light source. The projection display apparatus includes an element control unit that controls the imager; and a light source control unit that controls the light source. The element control unit controls the imager based on an image output signal obtained by a signal expansion process of an image input signal. The light source control unit performs a power reduction process of reducing power supplied to the light source according to an expansion amount of the image input signal expanded by the signal expansion process. The light source control unit performs a light emission period control process of adjusting light emission periods of a color component light beams of a plurality of colors emitted from the light source within a 1-frame period according to the image input signal.

According to embodiments, since a light emission period control process is performed according to an image input signal, it is possible to suppress a graduation crush between low luminance pixels. Moreover, since a power reduction process of reducing a power supplied to a light source according to an expansion amount of the image input signal is performed, the degree of freedom of the control process of the power finally supplied to the light source (power adjustment process) increases.

### First Embodiment

### (Configuration of a Projection Display Apparatus)

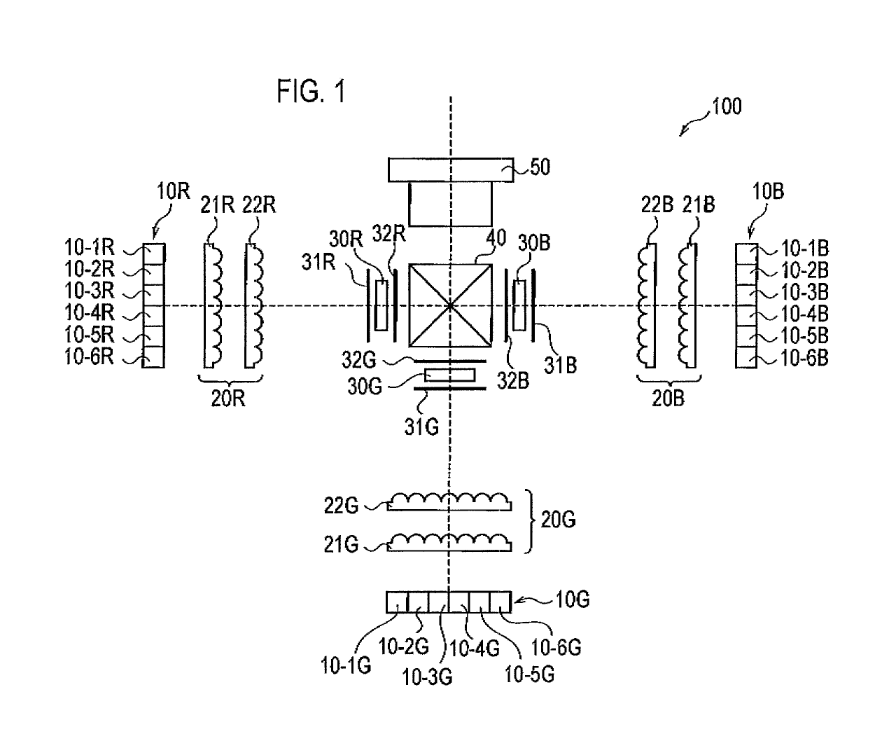

Hereinafter, the configuration of the projection display apparatus according to a first embodiment is explained with reference to drawings. FIG. 1 is a diagram illustrating the configuration of the projection display apparatus 100 according to the first embodiment.

As illustrated in FIG. 1, the projection display apparatus 100 includes a plurality of light source units 10, a plurality of fly eye lens units 20, a plurality of liquid crystal panels 30, a cross dichroic prism 40, and a projection lens unit 50,

The plurality of light source units 10 include a light source unit 10R, a light source unit 10G, and a light source unit 10B. Each light source unit 10 is formed by a plurality of solid state light sources. Examples of the solid state light source include an LD (Laser Diode) and LED (Light Emitting Diode). The light source unit 10R is formed by a plurality of solid state light sources (10-1R to 10-6R) that emits red component light R. The light source unit 10G is formed by a plurality of solid state light sources (10-1G to 10-6G) that emits green component light G. The light source unit 10B is formed by a plurality of solid state light sources (10-1B to 10-6B) that emits blue component light B.

The plurality of fly eye lens units 20 include a fly eye lens unit 20R, a fly eye lens unit 20G, and a fly eye lens unit 20B. Each fly eye lens unit 20 is formed by a fly eye lens 21 and a fly eye lens 22. The fly eye lens 21 and the fly eye lens 22 are formed by a plurality of minute lenses, respectively. Each minute lens collects light emitted by each light source unit 10 so that the entire surface of each liquid crystal panel 30 is irradiated with the light emitted by each light source unit 10.

The plurality of liquid crystal panels 30 include a liquid crystal panel 30R, a liquid crystal panel 30G, and a liquid crystal panel 30B. The liquid crystal panel 30R modulates the red component light R by rotating a polarization direction of the red component light R. On a light incidence surface side of the liquid crystal panel 30R, an incidence side deflection plate 31R configured to transmit light having one polarization direction (for example, P-polarization) and shield light having another polarization direction (for example, an S-polarization) is arranged. On a light emitting surface side of the liquid crystal panel 30R, an emitting side deflection plate 32R configured to shield light having one polarization direction (for example, P-polarization) and transmit light having another polarization direction (for example, an S-polarization) is arranged.

Similarly, the liquid crystal panel 30G and the liquid crystal panel 30B modulate the green component light G and the blue component light B by rotating polarization directions of the green component light G and the blue component light B, respectively. On a light incidence surface side of the liquid crystal panel 30G, an incidence side deflection plate 31G is arranged, and on a light emitting surface side of the liquid crystal panel 30G, an emitting side deflection plate 32G is arranged. On a light incidence surface side of the liquid crystal panel 30B, an incidence side deflection plate 31B is arranged, and on a light emitting surface side of the liquid crystal panel 30B, an emitting side deflection plate 32B is arranged.

The cross dichroic prism 40 combines light beams emitted from the liquid crystal panel 30R, the liquid crystal panel 30G, and the liquid crystal panel 30B. The cross dichroic prism 40 emits the combined light to a projection lens unit 50 side.

The projection lens unit 50 projects the combined light (image light) emitted from the cross dichroic prism 40 onto a screen, etc.

### (Configuration of a Control Unit)

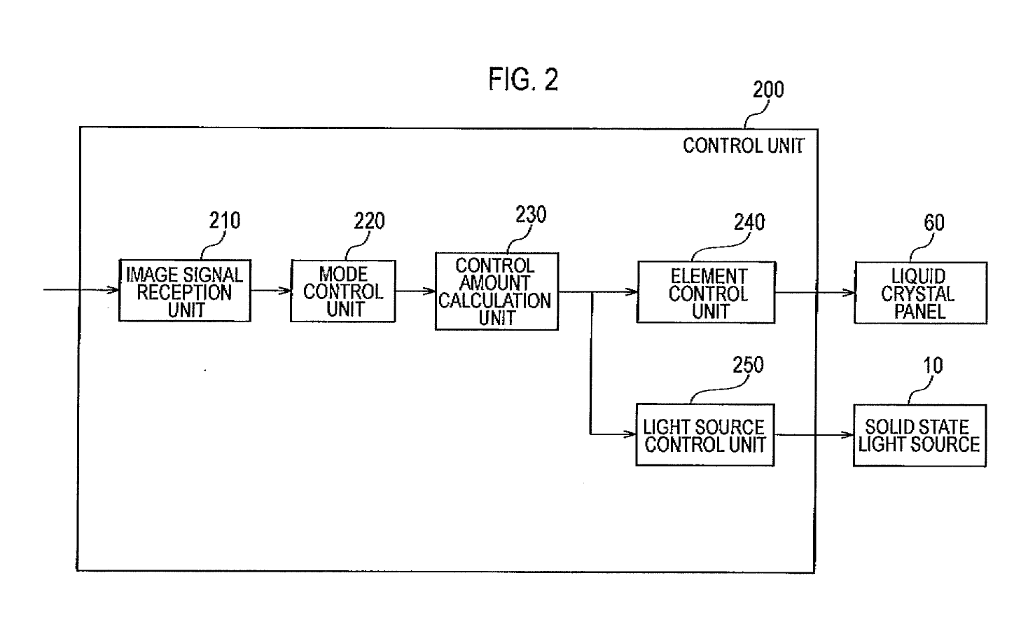

Hereinafter, the control unit according to the first embodiment is explained with reference to drawings. FIG. 2 is a block diagram illustrating the control unit 200 according to the first embodiment. The control unit 200 is arranged in the projection display apparatus 100 and controls the projection display apparatus 100.

The control unit 200 converts the image input signal into an image output signal. The image input signal is includes a red input signal Rᵢₙ, a green input signal Gᵢₙ, and a blue input signal Bᵢₙ. The image output signal includes a red output signal Rₒᵤₜ, a green output signal Gₒᵤₜ, and a blue output signal Bₒᵤₜ. The image input signal and the image output signal are input for each plurality of pixels configuring one frame.

It is noted that lower limit values of the image input signal and the image output signal are “0”, for example, and upper limit values of the image input signal and the image output signal are “255”, for example.

As illustrated in FIG. 2, the control unit 200 includes an image signal reception unit 210, a mode control unit 220, a control amount calculation unit 230, an element control unit 240, and a light source control unit 250.

The image signal reception unit 210 receives an image input signal from an external device (not shown) such as a DVD and a TV tuner.

The mode control unit 220 controls a high efficiency mode and a high luminance mode. The high efficiency mode is a control mode in which the power and the image input signal that should be supplied to the light source unit 10 are controlled during the light emission period of the color component light beams of a plurality of colors emitted from the light source unit 10 within a 1-frame period so that a light emission efficiency of the light source is high. The high luminance mode is a control mode in which the power and the image input signal that should be supplied to the light source unit 10 are controlled during the light emission period of the color component light beams of a plurality of colors emitted from the light source unit 10 within a 1-frame period so that an image luminance is high.

For example, the mode control unit 220 may select the control mode according to the image input signal. Specifically, the mode control unit 220 selects the high efficiency mode as the control mode, when a ratio of a pixel having a luminance lower than a predetermined luminance to a plurality of pixels configuring one frame is higher than a predetermined ratio. On the other hand, the mode control unit 220 selects the high luminance mode as the control mode, when a ratio of a pixel having a luminance lower than a predetermined luminance to a plurality of pixels configuring one frame is lower than a predetermined ratio.

The control amount calculation unit 230 calculates an adjustment amount of the light emission period of the color component light beams of a plurality of colors, and a control amount of the power and a control amount of the image input signal that should be supplied to the light source unit 10, according to the control mode selected by the mode control unit 220. The control amount calculation unit 230 outputs the control amount of the power, to the light source control unit 250. The control amount calculation unit 230 outputs the control amount of the image input signal, to the element control unit 240.

Hereinafter, a process of controlling the image input signal is referred to as “signal expansion process”. A process of reducing the power supplied to the light source unit 10 in response to the extension amount of the image input signal expanded by the signal expansion process is referred to as “power reduction process”. A process of adjusting the light emission period is referred. to as “light emission period control process (or Duty control process)”. Further, a process of controlling the power finally supplied to the light source unit 10 is referred to as “power adjustment process”.

The element control unit 240 converts the image input signal into the image output signal, and controls the liquid crystal panel 30 based on the image output signal. Specifically, the element control unit 240 converts the image input signal into the image output signal, based on the control amount input from the control amount calculation unit 230.

More particularly, the element control unit 240 converts the image input signal into the image output signal by expanding the image input signal by the signal expansion process. It is noted that element control unit 240 may perform a gamma correction, etc., in addition to the signal expansion process.

The light source control unit 250 controls the light source unit 10. Specifically, light source control unit 250 adjusts the light emission period of the color component light beams of a plurality of colors emitted from the light source unit 10 within a 1-frame period, based on the adjustment amount input from the control amount calculation unit 230. The light source control unit 250 controls the power that should be supplied to the light source unit 10 based on the control amount input from the control amount calculation unit 230.

More particularly, the light source control unit 250 performs the power reduction process according to the expansion amount of the image input signal expanded by the signal expansion process. The light source control unit 250 performs the light emission period control process (or the Duty control process) according to the image input signal. The light source control unit 250 performs a final power adjustment process according to the types of mode.

### (High Efficiency Mode and High Luminance Mode)

Hereinafter, the high efficiency mode and the high luminance mode according to the first embodiment will be explained.

### (Common Control 1)

Firstly, the control unit 200 creates histograms of red, green, and blue respectively regarding a plurality of pixels configuring one frame. Subsequently, the control unit 200 specifies a representative pixel value of red, blue, and green. The representative pixel value may be a maximum pixel value, a most frequent pixel value, a minimum pixel value, or an intermediate pixel value, for example.

Now consider a case where a representative pixel value (R, G, B) is (200, 128, 64), for example, as illustrated in Fig, 3. In this case, the light emission period of each color component light within a 1-frame period is a default value (for example, ⅓×1 frame period). A current value supplied to each light source unit 10 (the light source unit 10R, the light source unit 10G, and the light source unit 10B) is a default value.

### (Common Control 2)

Secondly, the control unit 200 expands the image input signal. The control unit 200 calculates the light emission period of each color component light shortened according to the expansion amount of the image input signal. Specifically, the control unit 200 expands the image input signal so that the representative pixel value becomes the upper limit value.

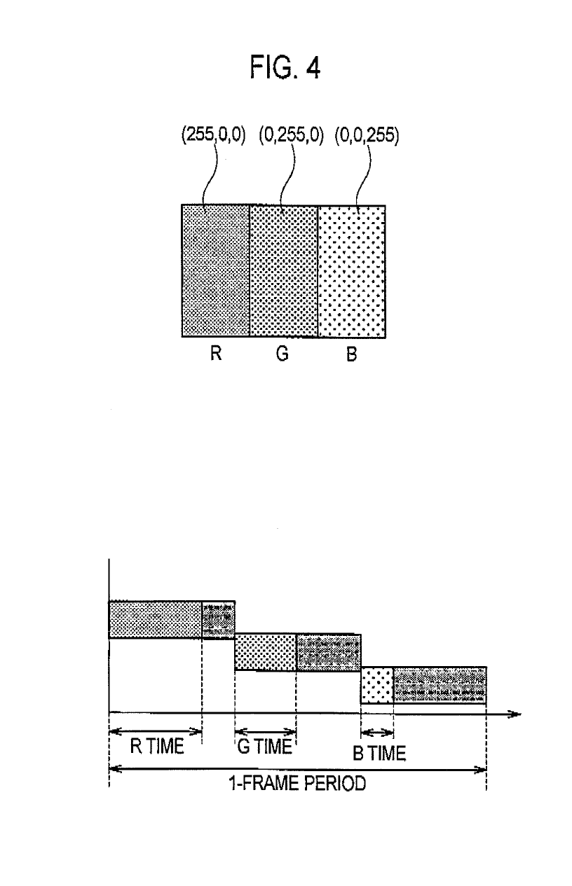

For example, as illustrated in FIG. 4, the image input signal is expanded so that the representative pixel values (200, 128, 64) becomes the upper limit values (255, 255, 255). That is, the red input signal Rᵢₙ is multiplied by “ 255/200”, the green input signal Gᵢₙ is multiplied by “255/128”, and the blue input signal Bᵢₙ is multiplied by “ 255/64”.

The light emission period of the red component light R is shortened by “ 200/255” or inverse number of the expansion amount of the red input signal Rᵢₙ. The light emission period of the green component light G is shortened by “ 128/255” or inverse number of the expansion amount of the green input signal Gᵢₙ. The light emission period of the blue component light B is shortened by “ 64/255” or inverse number of the expansion amount of the blue input signal Bᵢₙ.

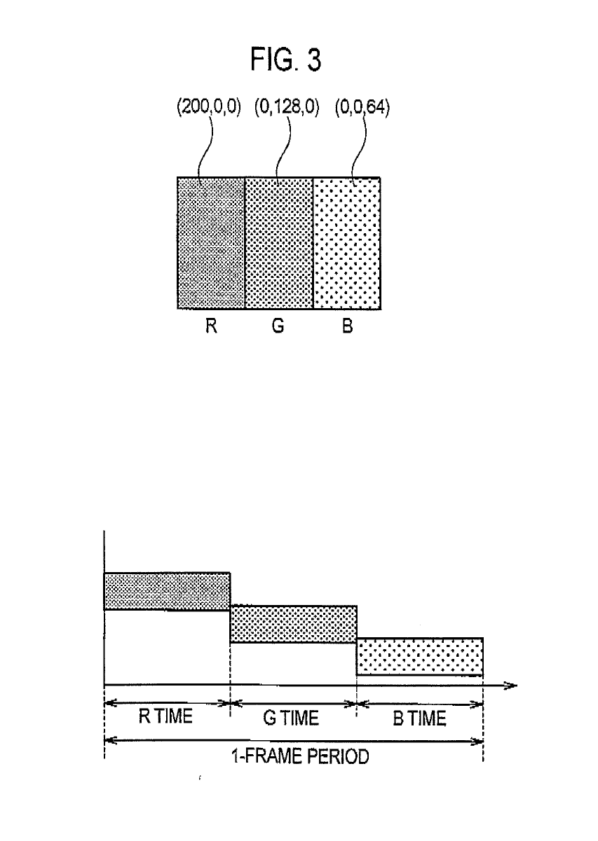

It should be noted that the luminance of the image is canceled out by the expansion of the image input signal and the shortening of the light emission period, and therefore, the luminance of the image illustrated in FIG. 4 is similar to the luminance of the image illustrated in FIG. 3.

### (Common Control 3)

Thirdly, the control unit 200 expands the light emission period of the color component light beams of a plurality of colors within a 1-frame period while maintaining the ratio of the light emission period of the color component light beams of a plurality of colors shortened according to the expansion amount of the image input signal.

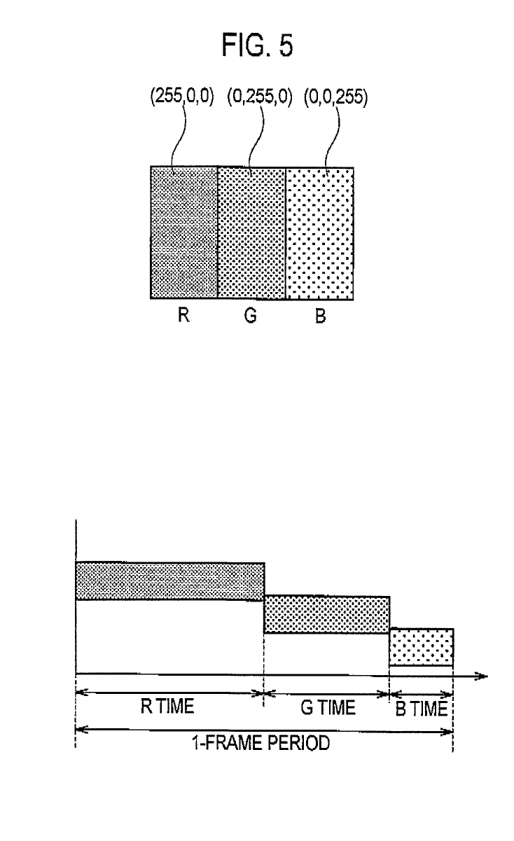

For example, as illustrated in FIG. 5, the light emission periods of the red component light R, the green component light G, and the blue component light B are expanded so that all the light emission periods expand to the entire 1-frame period while maintaining a ratio of “200: 128: 64”.

It should be noted that the luminance of the image increases due to the expansion of the light emission period, and therefore, the luminance of the image illustrated in FIG. 5 is higher than the luminance of the image illustrated in FIG. 3 and FIG. 4.

### (High Luminance Mode)

The control unit 200 performs at least processes of the common control 1 up to the common control 3 in the high luminance mode. This serves to improve the high luminance of the image.

It is noted that the control unit 200 may increase the current value that should be supplied to the light source unit 10 than the default value so as long not to exceed a permitted current value that can be supplied to the light source unit 10 in the high luminance mode.

### (High Efficiency Mode)

The control unit 200 performs at least processes of the common control 1 up to the common control 3 in the high efficiency mode. Moreover, in the high efficiency mode, the control unit 200 decreases the current value that should be supplied to the light source unit 10 in each of the light emission periods of color component light beams of a plurality of colors, according to the expansion amount of the light emission periods.

For example, in the examples illustrated in FIG. 3 to FIG. 5, the light emission period illustrated in FIG. 4 has been expanded to the light emission period illustrated in FIG. 5, and therefore, the current values that should be supplied to each light source unit 10 (light source unit 10R, the light source unit 10G, and the light source unit 10B) decrease, according to the expansion amount of the light emission period of each color component light.

[0] As a result, the light source unit 10 is operated in a range of a relatively low current value, and therefore, the light emission efficiency of the light source unit 10 rises,

### (Operation and Effect)

In the first embodiment, the control unit 200 controls the high luminance mode and the high efficiency mode. In the high luminance mode, the control unit 200 expands the light emission period of the color component light beams of a plurality of colors within a 1-frame period. Therefore, in the high luminance mode, there occurs no graduation crush between the low luminance pixels. On the other hand, in the high efficiency mode, it is possible to implement the saving of the power that should be supplied to the light source, and it is also possible to suppress the graduation crush between the low luminance pixels.

Specifically, in the high luminance mode, the control unit 200 expands the light emission period of the color component light beams of a plurality of colors within a 1-frame period while maintaining the ratio of the light emission period of the color component light beams of a plurality of colors shortened according to the expansion amount of the image input signal. Therefore, in the high luminance mode, the image luminance rises in accordance with the expansion of the light emission period.

On the other hand, in the high efficiency mode, the control unit 200 decreases the current value that should be supplied to the light source unit 100 in each of the light emission periods of the color component light beams of a plurality of colors, according to the expansion amount of the light emission period of the color component light beams of a plurality of colors within a 1-frame period. As a result, the light source unit 10 is operated in a range of a relatively low current value, and therefore, the light emission efficiency of the light source unit 10 rises. In the high efficiency mode, the light emission period of the color component light beams of a plurality of colors is expanded, and in this state, the current value that should be supplied to the light source unit 10 decreases, Therefore, it is possible to suppress the graduation crush between the low luminance pixels.

### (First Modification)

Hereinafter, a first modification of the first embodiment is explained. The explanation below is based primarily on the differences with respect to the first embodiment.

Specifically, in the first embodiment, a case where the red component light R, the green component light G, and the blue component light B are independently emitted within a 1-frame period has been described. That is, in the first embodiment, an R period, a G period, and a B period are arranged within a 1-frame period.

On the other hand, in a first modification, the red component light R, the green component light G, and the blue component light B are emitted within a 1-frame period in an overlapping manner, That is, in the first modification, in addition to the R period, the G period, and the B period, a Y period, a C period, an M period, and a W period are arranged within a 1-frame period, for example. It is noted that the Y period (yellow) is a period during which the red component light R and the green component light G are emitted, the C period (cyan) is a period during which the green component light G and the blue component light B are emitted, the M period (magenta) is a period during which the red component light R and the blue component light B are emitted, and the W period (white) is a period during which the red component light R, the green component light G, and the blue component light B are emitted.

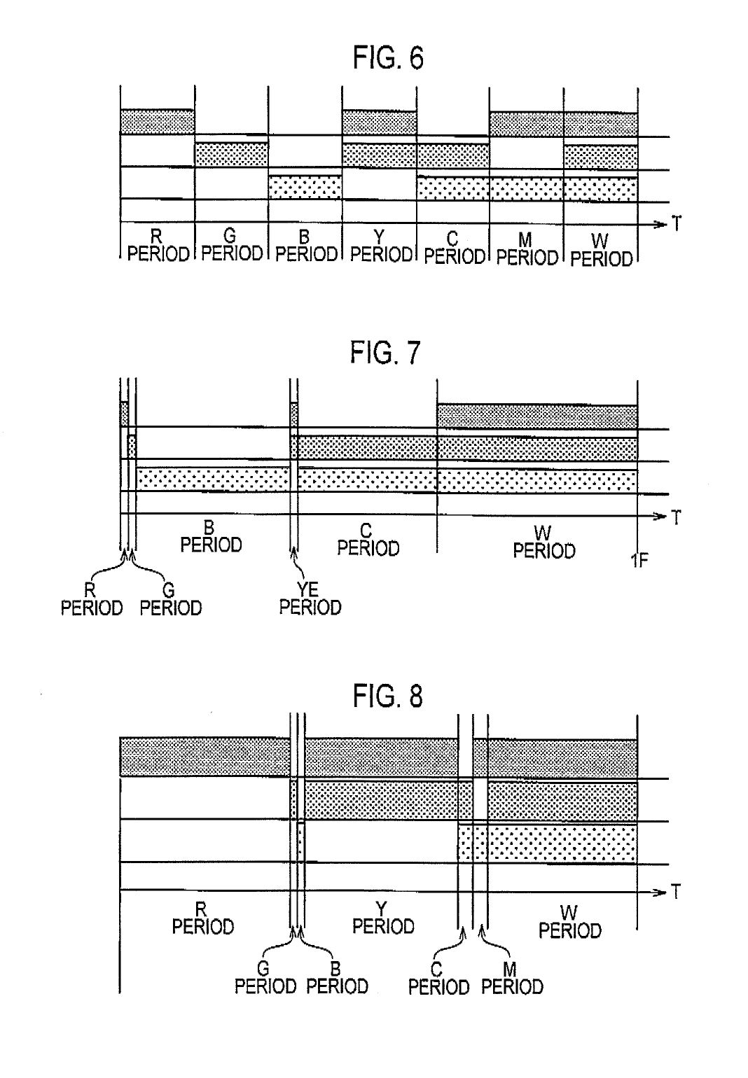

As illustrated in FIG. 6, in a default state, the R period, the G period, the B period, the Y period, the C period, the M period, and the W period have an equal time length.

For example, in an image having a high ratio of blue or cyan and a high luminance, the B period, the C period, and the W period are significantly expanded, and the other periods are shortened, as illustrated in FIG. 7.

On the other hand, in an image having a high ratio of red or yellow and a high luminance, the R period, the Y period, and the W period are significantly expanded, and the other periods are shortened, as illustrated in FIG. 8.

It is noted that in such cases, in the common control 1, histograms of yellow, cyan, magenta, and white are created in addition to those of red, green, and blue, and representative pixel values of yellow, cyan, magenta, and white are specified in addition to those of red, blue, and green.

### (Operation and Effect)

In the first modification, six types of light emission periods are arranged within a 1-frame period. Therefore, it is possible to adjust each light emission period more dynamically, and it is possible to implement a further increase of a light amount as one whole frame.

### Example

Hereinafter, examples of the first embodiment are explained. The explanation below is based primarily on the differences with respect to the first embodiment.

It is noted that in the examples, a case where the representative pixel values (R, G, B) are (200, 150, 180) is mainly provided. As described above, the representative pixel values (R, G, B) are acquired by the histogram of the image input signal, for example.

In the examples, a case where as the power supplied to each light source unit 10, a current value is controlled is provided.

In this case, in the examples, an element configured to express luminance by switching between illumination and non-illumination in a time division manner such as DMD (Digital Micromirror Device) is provided as an imager. Therefore, it should be noted that a minimum light emission period of each light source unit 10 (i.e., each color component light) is similar to each representative pixel value (R, G, B).

### Control Example 1

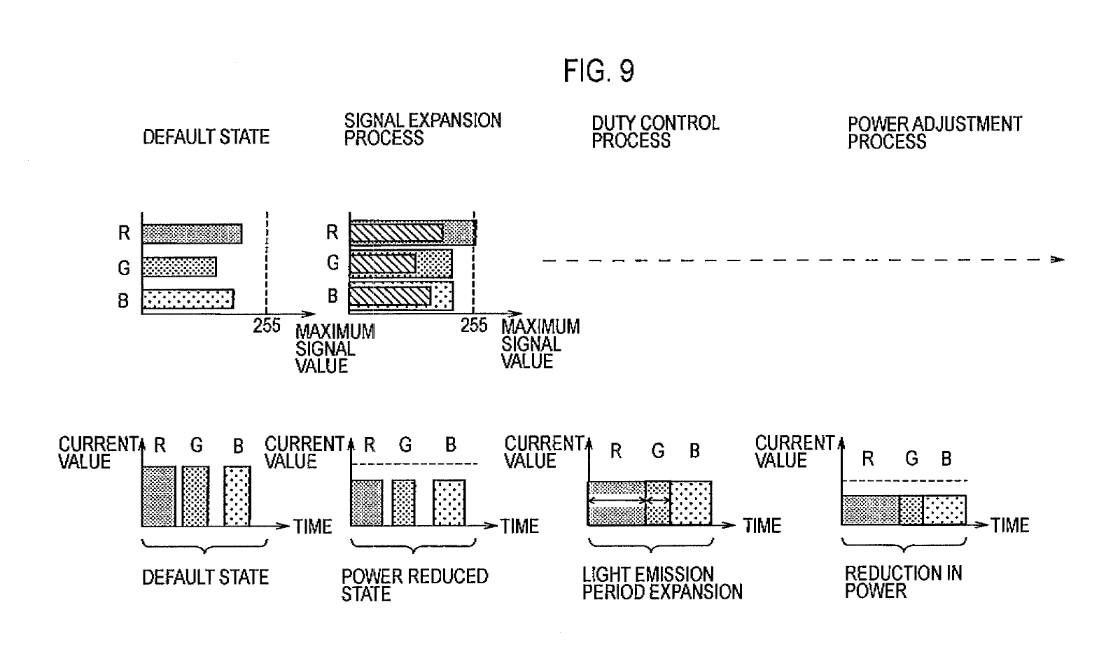

In a control example 1, as illustrated in FIG. 9, the following operations are performed in the signal expansion process, the power reduction process, the Duty control process, and the power adjustment process.

Firstly, in the signal expansion process, a maximum value (in this case, R=200), of the representative pixel values (R, G, B), is expanded to an upper limit value (for example, 255).

Secondly, in the power reduction process, according to an expansion amount (in this case, 255/200) of the image input signal expanded by the signal expansion process, the current value supplied to each light source unit 10 (the light source unit 10R, the light source unit 10G, and the light source unit 10B) is reduced uniformly.

Thirdly, in the Duty control process, the light emission period of each light source unit 10 (the light source unit 10R, the light source unit 10G, and the light source unit 10B) is controlled. Specifically, the light emission period of each light source unit 10 is expanded so that a total of light emission periods of all the light source units 10 is a 1-frame period while the ratio among the representative pixel values (R, G, B) is maintained.

Fourthly, in the power adjustment process, the power supplied to each light source unit 10 is reduced. A reduction width of the power supplied to each light source unit 10 is defined according to the control amount (expansion amount) of the light emission period.

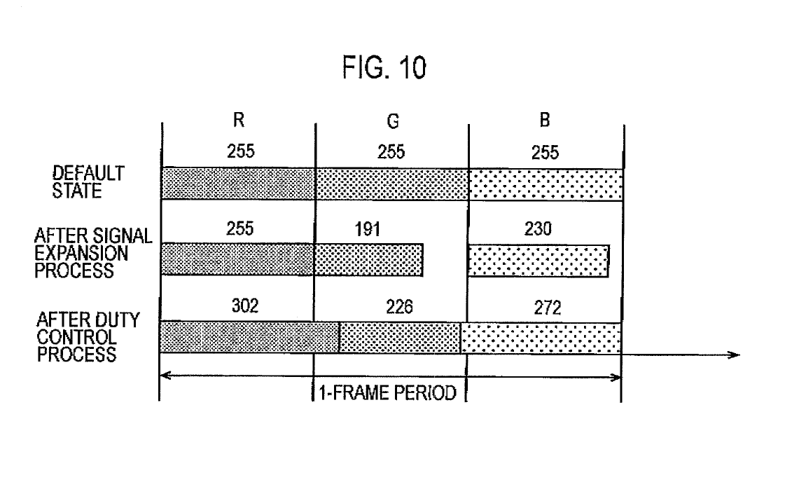

As a result of a series of such processes, the light emission period is controlled as illustrated in FIG. 10. Specifically, as illustrated in FIG. 10, each representative pixel value (R, G, B) is changed to (255, 191, 230) after the signal expansion process, and therefore, the light emission period of each light source unit 10 is (255, 191, 230). Further, in the Duty control process, the light emission period of each light source unit 10 is (288, 216, 260).

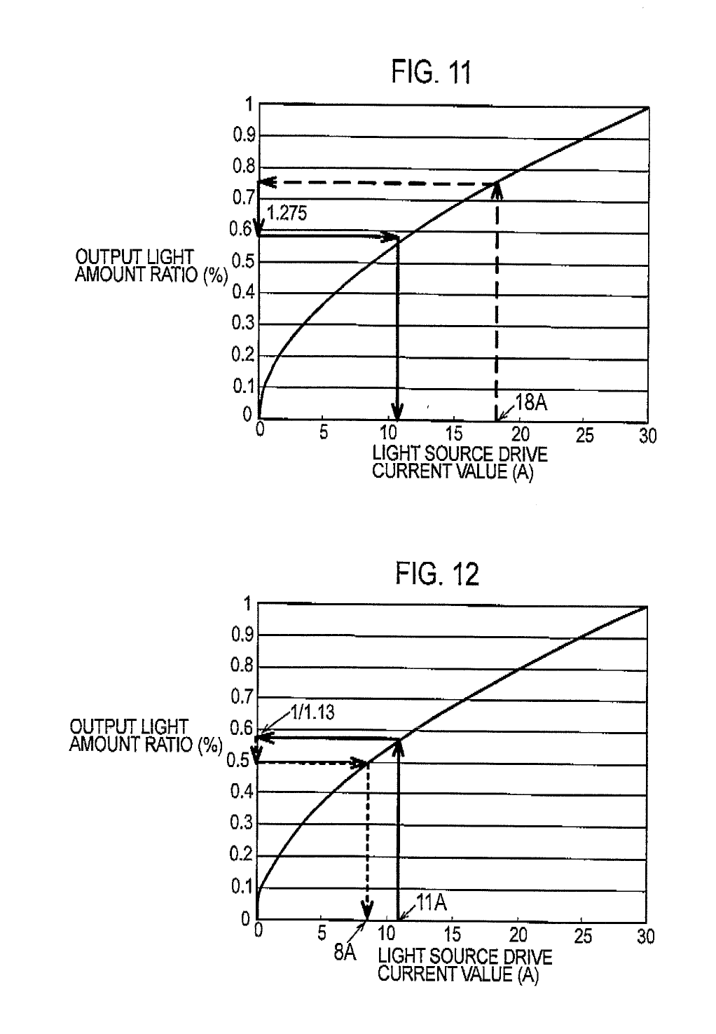

Moreover, as a result of a series of such processes, the power (in this case, the current value) supplied to each light source unit 10 is controlled as illustrated in FIG. 11 and FIG. 12. Specifically, as illustrated in FIG. 11, in the current value reduction process, the expansion amount of the image input signal along with the signal expansion process is “ 255/200=1.275”, and therefore, the current value supplied to the light source unit 10 is decreased so that the light amount emitted from the light source unit 10 is “ 1/1.275”. Moreover, in the power adjustment process, the expansion amount of the light emission period along with the Duty control process is “ 288/255=1.13”, and therefore, the current value supplied to the light source unit 10 is decreased so that the light amount emitted from the light source unit 10 is “ 1/1.13”.

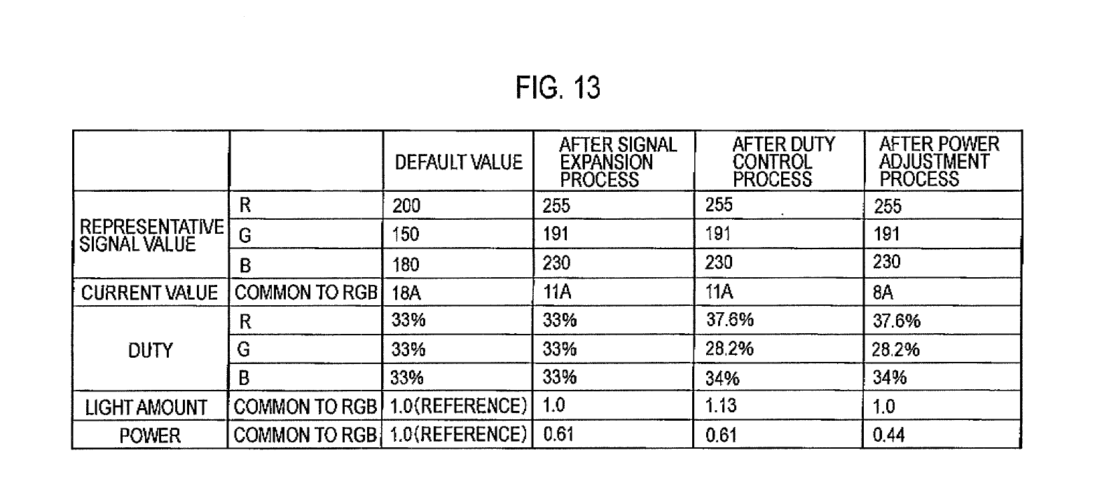

FIG. 13 is a table summarizing changes in the representative signal value, the current value, the Duty (light emission period), the light amount, and the power in the control example 1. As illustrated in FIG. 13, according to the control example 1, it can be read that the power that should be supplied to each light source unit 10 is reduced without changing the light amount. Thus, the control example 1 is one example of the high efficiency mode illustrated in the first embodiment.

### Control Example 2

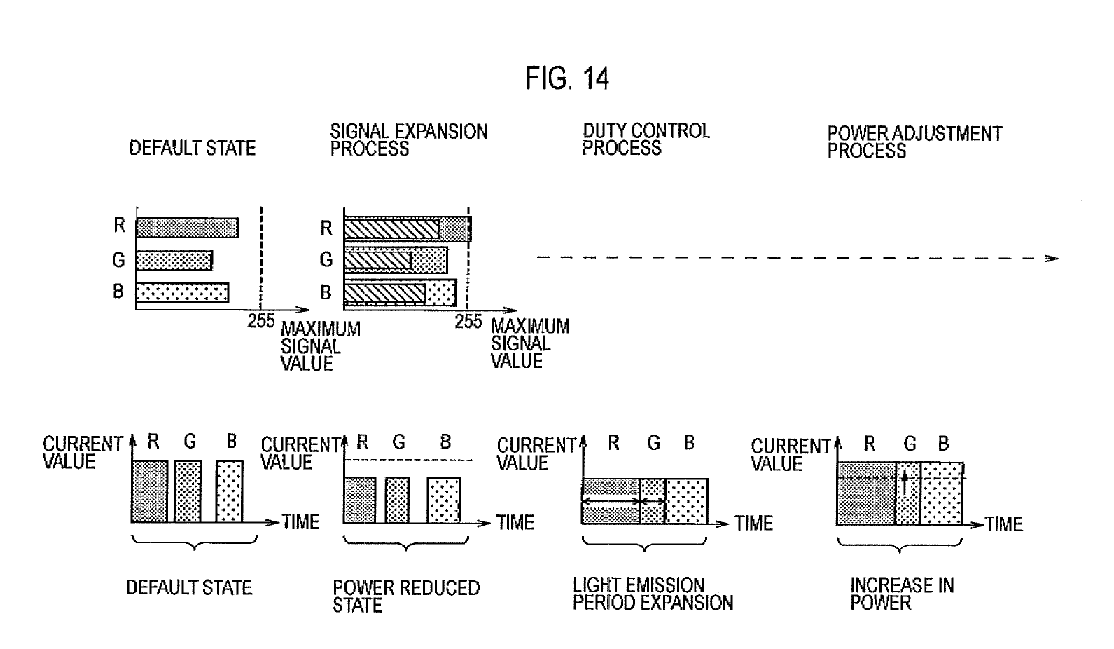

In a control example 2, as illustrated in FIG. 14, the following operations are performed in the signal expansion process, the power reduction process, the Duty control process, and the power adjustment process.

Firstly, in the signal expansion process, a maximum value (in this case, R=200), of the representative pixel values (R, G, B), is expanded to an upper limit value (for example, 255).

Secondly, in the power reduction process, according to an expansion amount (in this case, 255/200) of the image input signal expanded by the signal expansion process, the current value supplied to each light source unit 10 (the light source unit 10R, the light source unit 10G, and the light source unit 10B) is reduced uniformly.

Thirdly, in the Duty control process, the light emission period of each light source unit 10 (the light source unit 10R, the light source unit 10G, and the light source unit 10B) is controlled. Specifically, the light emission period of each light source unit 10 is expanded so that a total of light emission periods of all the light source units 10 is a 1-frame period while the ratio among the representative pixel values (R, G, B) is maintained.

Fourthly, in the power adjustment process, the power supplied to each light source unit 10 is increased. An increase width of the power supplied to each light source unit 10 is defined in a range not exceeding an allowed power value that can be supplied to the light source unit 10.

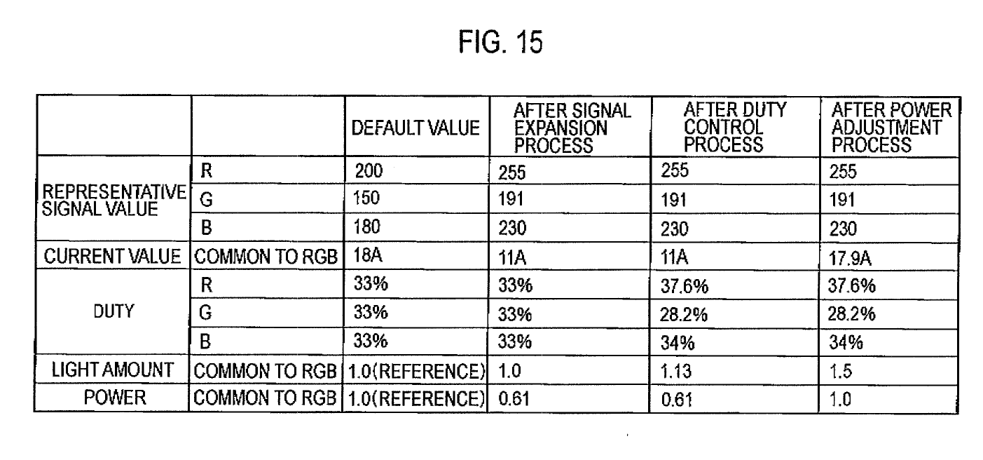

FIG. 15 is a table summarizing changes in the representative signal value, the current value, the Duty (light emission period), the light amount, and the power in the control example 2. As illustrated in FIG. 15, according to the control example 2, it can be read that the light amount increases without changing the power that should be supplied to each light source unit 10. Thus, the control example 2 is one example of the high luminance mode illustrated in the first embodiment.

### Control Example 3

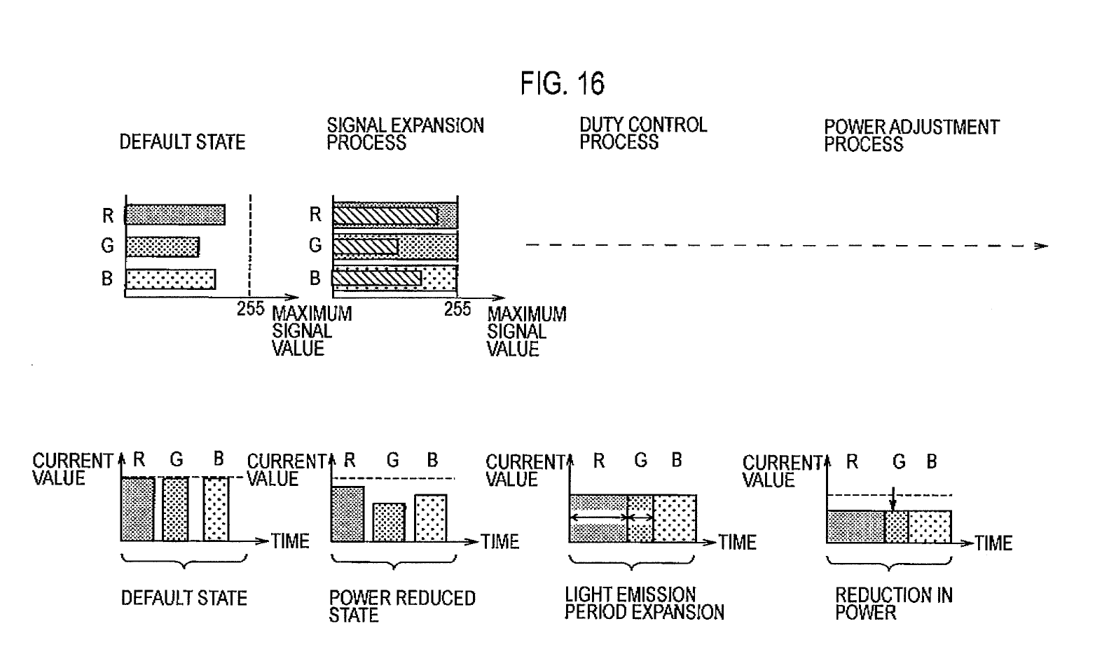

In a control example 3, as illustrated in FIG. 16, the following operations are performed in the signal expansion process, the power reduction process, the Duty control process, and the power adjustment process,

Firstly, in the signal expansion process, each representative pixel value (R, G, B) is expanded to an upper limit value (for example, 255).

Secondly, in the power reduction process, according to the expansion amount (in this case, 255/200, 255/150, and 255/180) of the image input signal expanded by the signal expansion process, the current value supplied to each light source unit 10 (the light source unit 10R, the light source unit 10G, and the light source unit 10B) is individually reduced.

Thirdly, in the Duty control process, the light emission period of each light source unit 10 (the light source unit 10R, the light source unit 10G, and the light source unit 10B) is controlled. Specifically, the light emission period of each light source unit 10 is expanded so that a total of light emission periods of all the light source units 10 is a 1-frame period while the ratio among the representative pixel values (R, G, B) is maintained.

Fourthly, in the power adjustment process, the power supplied to each light source unit 10 is reduced. A reduction width of the power supplied to each light source unit 10 is defined according to the control amount (expansion amount) of the light emission period.

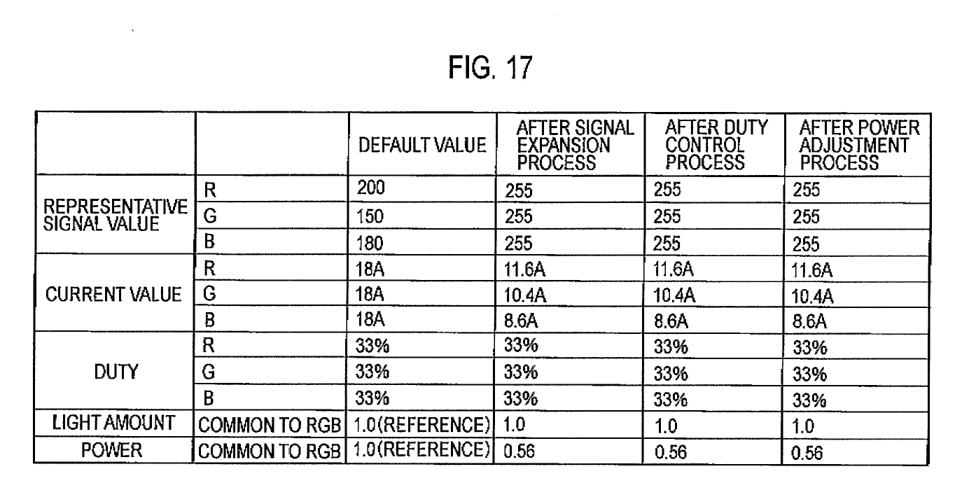

FIG. 17 is a table summarizing changes in the representative signal value, the current value, the Duty (light emission period), the light amount, and the power in the control example 3. As illustrated in FIG. 17, according to the control example 3, it can be read that the power that should be supplied to each light source unit 10 is reduced without changing the light amount, Thus, the control example 3 is one example of the high efficiency mode illustrated in the first embodiment.

### Control Example 4

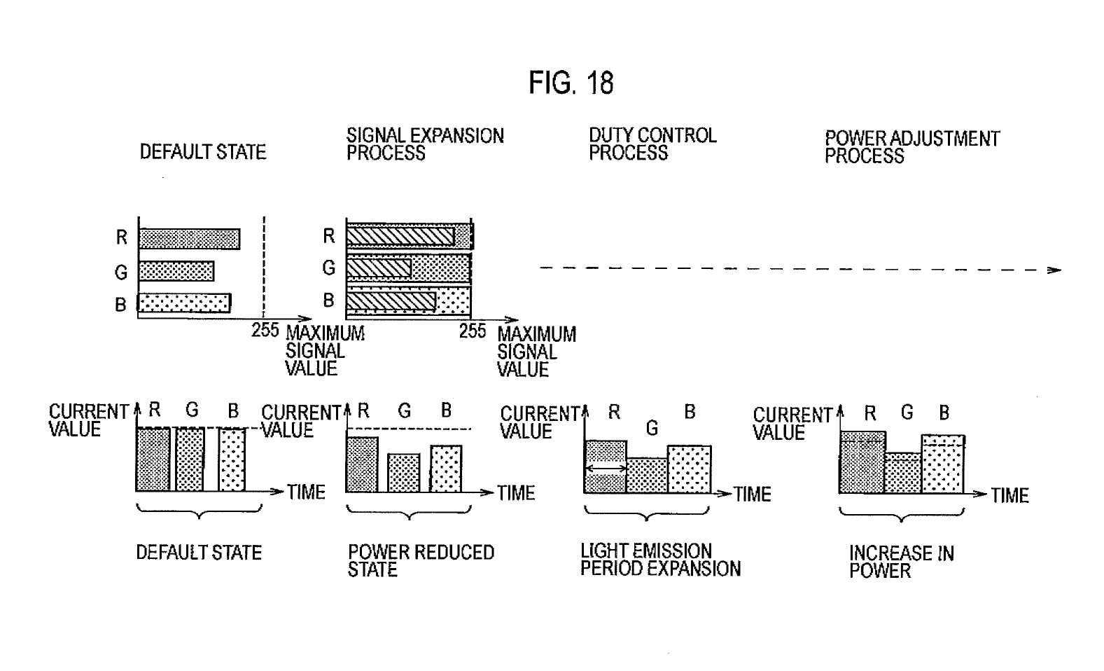

In a control example 4, as illustrated in FIG. 18, the following operations are performed in the signal expansion process, the power reduction process, the Duty control process, and the power adjustment process.

Firstly, in the signal expansion process, each representative pixel value (R, G, B) is expanded to an upper limit value (for example, 255).

Secondly, in the power reduction process, according to the expansion amount (in this case, 255/200, 255/150, and 255/180) of the image input signal expanded by the signal expansion process, the current value supplied to each light source unit 10 (the light source unit 10R, the light source unit 10G, and the light source unit 10B) is individually reduced.

Thirdly, in the Duty control process, the light emission period of each light source unit 10 (the light source unit 10R, the light source unit 10G, and the light source unit 10B) is controlled. Specifically, the light emission period of each light source unit 10 is expanded so that a total of light emission periods of all the light source units 10 is a 1-frame period while the ratio among the representative pixel values (R, G, B) is maintained.

Fourthly, in the power adjustment process, the power supplied to each light source unit 10 is increased. An increase width of the power supplied to each light source unit 10 is defined in a range not exceeding an allowed power value that can be supplied to the light source unit 10,

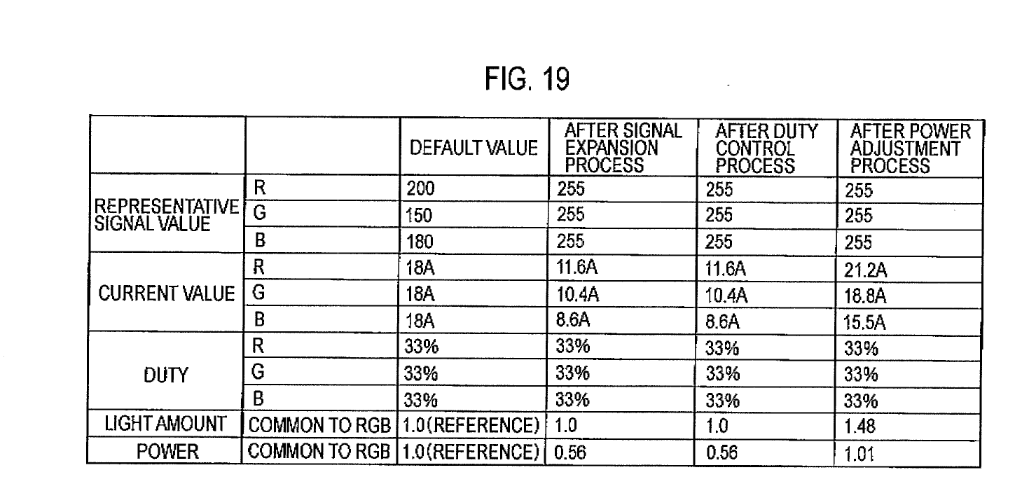

FIG. 19 is a table summarizing changes in the representative signal value, the current value, the Duty (light emission period), the light amount, and the power in the control example 4. As illustrated in FIG. 19, according to the control example 4, it can be read that the light amount increases without changing the power that should be supplied to each light source unit 10. Thus, the control example 4 is one example of the high luminance mode illustrated in the first embodiment,

### Another Control Example

In the control examples 1 to 4, a case where in the Duty control process, the light emission period of each light source unit 10 is expanded so that a total of light emission periods of all the light source units 10 is a 1-frame period while the ratio among the representative pixel values (R, G, B) is maintained is illustrated,

However, the control example is not limited thereto. For example, based on the image input signal, one frame of color distribution is acquired, and the light emission period of each light source unit 10 may be expanded according to the one frame of color distribution.

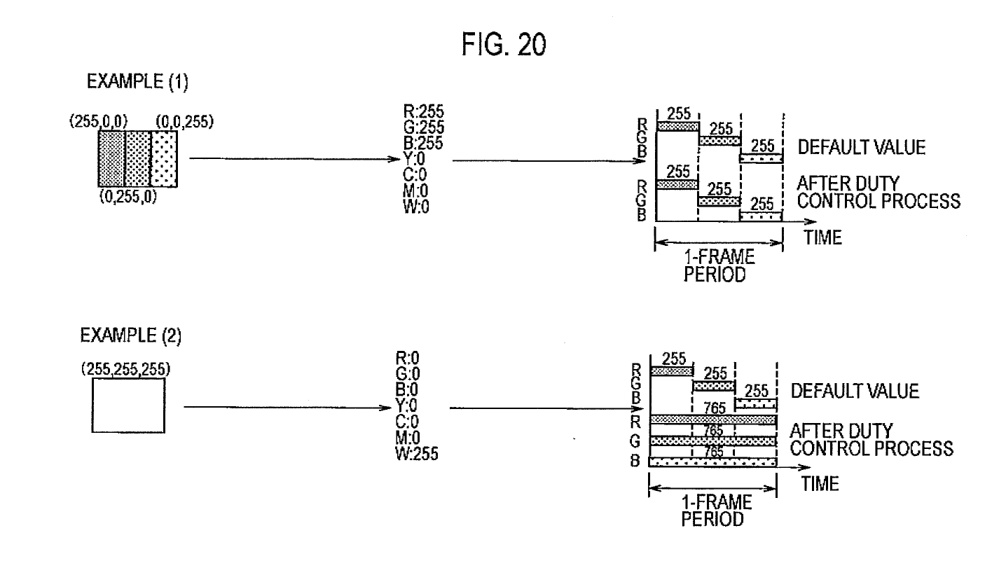

More particularly, as illustrated in the first example of FIG. 20, when a saturation of a color such as red, blue, and green is large in the one frame of color distribution, a default value is maintained as the light emission period of each light source unit 10.

On the other hand, as illustrated in the second example of FIG. 20, when the saturation is very low in the one frame of color distribution, for example, when the entire one frame is white, all the light emission periods of each light source unit 10 are expanded to a 1-frame period.

It is noted that although not illustrated here, when the saturation of yellow is high, the light emission periods of the light source unit 10R and the light source unit 10G are significantly expanded. Similarly, when the saturation of cyan is high, the light emission periods of the light source unit 10G and the light source unit 10B are significantly expanded, and when the saturation of magenta is very high, the light emission periods of the light source unit 10R and the light source unit 10B are significantly expanded.

### Other Embodiments

The present invention is explained through the above embodiment, but it must not be assumed that this invention is limited by the statements and drawings constituting a part of this disclosure. From this disclosure, various alternative embodiments, examples and operational technologies will become apparent to those skilled in the art.

In the embodiment, the mode control unit 220 selects the control mode based on the image input signal. However, the embodiment is not limited thereto. For example, the mode control unit 220 may select the control mode according to a user's operation.

In the aforementioned embodiment, the liquid crystal panel 30 is used as the imager; however, the present invention is not limited thereto. As the imager, LCOS (Liquid Crystal on Silicon), DMD (Digital Micromirror Device), etc., may be used.

Although not particularly described in the embodiment, it is preferable that when a three-dimensional image formed by a plurality of viewpoint images is displayed, the control unit 200 applies the same light emission period, as the light emission period of the color component light beams of a plurality of colors within a 1-frame period, to a plurality of viewpoint images. Moreover, it is preferable that the control unit 200 applies the same current value, as the current vale that should be supplied to the light source unit 10 in each of the light emission periods of the color component light beams of a plurality of colors, to a plurality of viewpoint images.

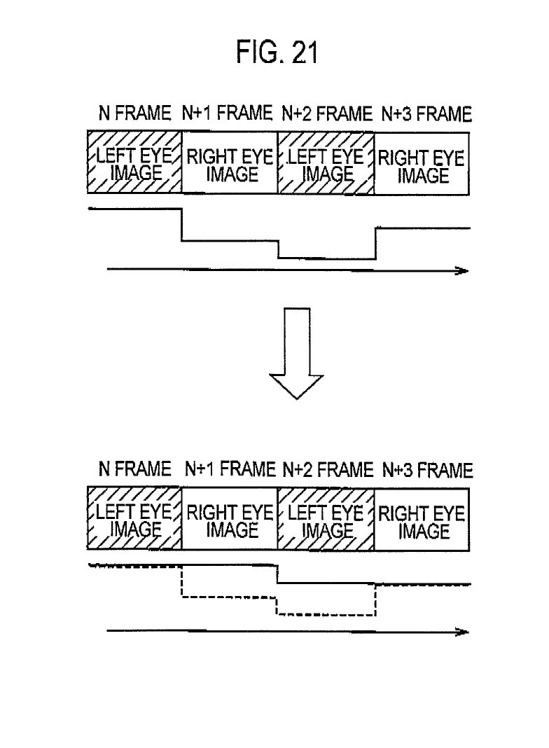

Specifically, as illustrated in FIG. 21, in an odd-numbered frame (n+1 or n+3), for example, control similar to that for an even-numbered frame (n or n+2) is applied. This suppresses generation of a difference in luminance between frames configuring the three-dimensional image. Needless to say, in the even-numbered frame (n or n+2), control similar to that for the odd-numbered frame (n+1 or n+3) may be applied.

Although not particularly described in the embodiment, in the current control process in the high luminance mode (the aforementioned control example 2 or control example 4), an increase amount of the power supplied to each light source unit 10 may be determined by a permitted cooling range determined by a cooling capacity of each light source unit 10.

Specifically, the heat generated in each light source unit 10 is determined by the power supplied to each light source unit 10 and the light emission period of each light source unit 10. In this case, if the heat generated by the light source unit 10 is too small, then supercooling occurs in the light source unit 10 by the cooling of the light source unit 10. On the other hand, if the heat generated by the light source unit 10 is too large, the cooling of the light source unit 10 is insufficient.

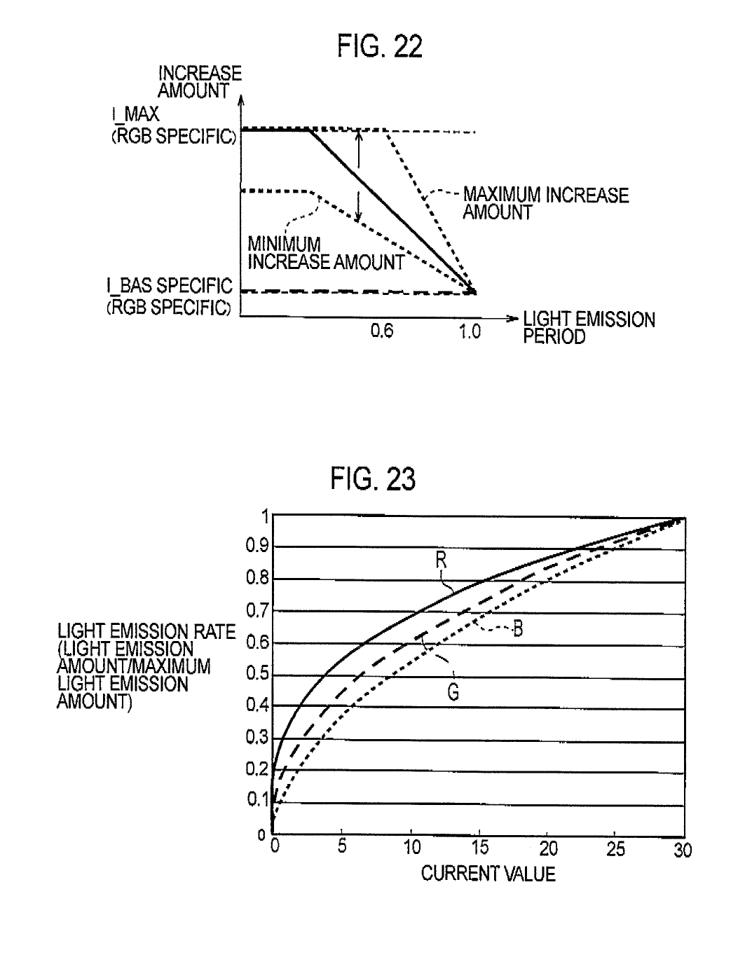

More particularly, as illustrated in FIG. 22, the increase amount of power is determined in a range not falling below a minimum increase amount and not exceeding a maximum increase amount. Needless to say, the increase amount of power is smaller when the light emission period is longer. In other words, the allowed power value that can be supplied to the light source unit 10 is determined by the permitted cooling range determined by the cooling capacity of the light source unit 10.

It is noted that the permitted cooling range (i.e., allowed power value) may differ depending on each light source unit 10 (the light source unit 10R, the light source unit 10G, and the light source unit 10B).

As described in the control example 1 to the control example 4, the light emission period works together with the representative pixel value, and therefore, the signal expansion process is preferably performed based on the permitted cooling range (i.e., allowed power value).

Although not particularly described in the embodiments, as illustrated in FIG. 23, a light emission characteristic of the light source unit 10 may differ depending on each light source unit 10 (the light source unit 10R, the light source unit 10G, and the light source unit 10B). In such a case, in the aforementioned power reduction process or power adjustment process, the powers of each light source unit 10 are individually controlled based on the light emission characteristic of each light source unit 10.

Although not particularly described in the embodiments, in the light source unit 10, a light source unit (LD) having a more improved efficiency in proportion to a larger power and a light source unit (LED) having a more improved efficiency in proportion to a smaller power may exist.

The signal expansion process, the power reduction process, the Duty control process, and the power adjustment process are preferably performed based on the light emission characteristic of the light source unit 10. For example, it may be possible to shorten the light emission period of the light source unit 10 formed by LD so as to increase the power supplied to the light source unit 10 formed by LD. On the other hand, it may be possible to expand the light emission period of the light source unit 10 formed by LED so as to decrease the power supplied to the light source unit 10 formed by LED.

What is claimed is:

1. A projection display apparatus including a light source that emits color component light beams of a plurality of colors and an imager that modulates the color component light beams of a plurality of colors emitted from the light source, comprising:
an element control unit that controls the imager; and
a light source control unit that controls the light source, wherein
the element control unit controls the imager based on an image output signal obtained by a signal expansion process of an image input signal,
the light source control unit performs a power reduction process of reducing power supplied to the light source according to an expansion amount of the image input signal expanded by the signal expansion process, and
the light source control unit performs a light emission period control process of adjusting light emission periods of a color component light beams of a plurality of colors emitted from the light source within a 1-frame period according to the image input signal.

2. The projection display apparatus according to claim 1, wherein
the light source control unit performs a power adjustment process of reducing power supplied to the light source according to an adjustment amount of the light emission period adjusted by the light emission period control process.

3. The projection display apparatus according to claim 1, wherein
the light source control unit performs a power adjustment process of increasing power supplied to the light source in a range not exceeding an allowed power value that can be supplied to the light source.

4. The projection display apparatus according to claim 1, wherein
the image input signal includes color input signals for each color component light beam of a plurality of colors, and
the element control unit applies an expansion amount of any one of a color input signal to the other color input signal, among the color input signals for each color component light beam of a plurality of colors, in the signal expansion process.

5. The projection display apparatus according to claim 1, wherein
the image input signal includes color input signals for each color component light beam of a plurality of colors,
in the color input signals for each color component light beam of a plurality of colors, an upper limit value is predefined, and
the element control unit expands each of the color input signals for each color component light beam of a plurality of colors to the upper limit value in the signal expansion process.

6. The projection display apparatus according to claim 1, wherein
when displaying a three-dimensional image formed by a plurality of viewpoint images, the element control unit and the light source control unit apply the same process, as the signal expansion process, the power reduction process, and the light emission period control process, to the plurality of viewpoint images.

7. The projection display apparatus according to claim 1, comprises a mode control unit that controls a high efficiency mode in which a light emission efficiency of the light source is high and a high luminance mode in which a luminance of an image is high.

8. The projection display apparatus according to claim 6, wherein
when displaying a three-dimensional image formed by a plurality of viewpoint images, the mode control unit applies the same control mode, among the high luminance mode and the high efficiency mode, to the plurality of viewpoint images.
